(19) United States
(12) Patent Application Publication
(10) Pub. No.: US 2011/0186714 A1
(43) Pub. Date: Aug. 4, 2011

(54) Adaptive De-Flicker Device and Method For Adaptive De-Flicker

(75) Inventors: Shang-Ming Hung, HsinChu City (TW); Chien-Teng Huang, HsinChu City (TW); Chin-Chou Lee, HsinChu City (TW); Jeng-Feng Lan, HsinChu City (TW); Chun-Huang Lin, HsinChu City (TW); Hao-Ming Hsu, HsinChu City (TW)

(73) Assignee: Chip Goal Electronics Corporation, R.O.C.

(21) Appl. No.: 12/758,985

(22) Filed: Apr. 13, 2010

Related U.S. Application Data
(63) Continuation-in-part of application No. 12/657,902, filed on Jan. 29, 2010.

(51) Int. Cl. G01J 1/44

(52) U.S. Cl. 250/214 AL

(57) ABSTRACT

The present invention discloses an adaptive de-flicker device and a method for adaptive de-flicker. The device includes: a light sensor for sensing ambient light and generating a corresponding sensed signal; a signal processor coupled to the light sensor, for generating a signal related to a frequency of the ambient light and a feedback signal according to the sensed signal generated by the light sensor; and an automatic gain control circuit coupled to the signal processor, for generating a control signal according to the feedback signal, to adjust the sensed signal by feedback controlling the light sensor, or to adjust the signal related to the frequency of the ambient light by feedback controlling the signal processor.

### CROSS-REFERENCE

The present application is a continuation-in-part application of the application of U.S. Ser. No. 12/657,902, filed on Jan. 29, 2010.

### BACKGROUND OF THE INVENTION

1. Field of Invention

The present invention relates to an adaptive de-flicker device and a method for adaptive de-flicker; particularly, it relates to an adaptive de-flicker device and a method for adaptive de-flicker with automatic gain control.

2. Description of Related Art

When ambient light comes from an indoor light source instead of a natural light source, a 50 Hz or 60 Hz flicker is generated according to the frequency of a power supply. To capture images by an image capture device (e.g., an image sensor) under such circumstance, it usually requires de-flickering to avoid inconsistency among brightness of the pictures. In general, de-flickering is processed by way of adjusting exposure time, wherein the exposure time is set to an integer multiple of 1/100 second when the frequency of the power supply is 50 Hz, and is set to an integer multiple of 1/120 second when the frequency of the power supply is 60 Hz. To determine the frequency of the ambient light wherein the image capture device is operated, the prior art provides two ways: The first way is to determine the 50 Hz or 60 Hz frequency by the geographical location where an apparatus using the image capture device (e.g., digital camera, digital video recorder, or monitor) is sold. The problem of this approach is that, for certain types of machines such as a digital video recorder, a user may use it in different geographical regions because of traveling. The other way is presently only applicable to a monitor system, wherein a power frequency sensor and a switch circuit are provided in addition to the monitor. The power frequency sensor determines whether the frequency of the power supply is 50 Hz or 60 Hz, and switches the monitor system to a corresponding frequency that is suitable for de-flicker. This approach is subject to a condition that the monitor system has to be placed in a fixed location, and supplied by a local power supply. However, if the machine is supplied by its own battery instead of the local power supply, such as a portable machine (e.g., a digital video recorder), it is not possible to obtain the frequency of the local power supply and to de-flicker accordingly.

In view of the foregoing, the present invention provides an adaptive de-flicker device and a method related thereto; particularly, the adaptive de-flicker device includes automatic gain control to improve accuracy of the overall circuitry.

### SUMMARY OF THE INVENTION

A first objective of the present invention is to provide an adaptive de-flicker device, which can be applied to, for example but not limited to, a system related to capturing images.

Another objective of the present invention is to provide a method for adaptive de-flicker.

To achieve the foregoing objectives, in one perspective of the present invention, it provides an adaptive de-flicker device comprising: a light sensor for sensing ambient light and generating a corresponding sensed signal; a signal processor coupled to the light sensor, for generating a signal related to a frequency of the ambient light and a feedback signal according to the sensed signal; and an automatic gain control circuit coupled to the signal processor, for generating a control signal according to the feedback signal, to adjust the sensed signal by feedback controlling the light sensor, or to adjust the signal related to the frequency of the ambient light by feedback controlling the signal processor.

In one embodiment, the automatic gain control circuit adjusts intensity of the sensed signal generated by the light sensor according to the feedback signal.

In another embodiment, the signal processor includes an amplifier amplifying the sensed signal generated by the light sensor, wherein the automatic gain control circuit adjusts the amplification ratio of the amplifier according to the feedback signal.

The automatic gain control circuit generates the control signal by, for example, comparing the feedback signal generated by the signal processor with a reference signal, or subtracting a reference signal from the feedback signal generated from the signal processor.

The light sensor preferably includes a plurality of light sensing devices of the same or different sizes; in this case, the intensity of the sensed signal can be adjusted by selectively coupling different number or different sizes of light sensing devices.

The amplifier preferably includes a current mirror circuit, and a switch circuit or a variable resistor. The amplification ratio of the amplifier can be adjusted by selectively coupling different number of current duplication paths in the current mirror, or by adjusting the resistance of the variable resistor.

In another perspective of the present invention, it provides a method for adaptive de-flicker, comprising: sensing ambient light and generating a corresponding sensed signal; amplifying the sensed signal; generating a signal related to a frequency of the ambient light and a feedback signal according to the amplified sensed signal; and generating a control signal according to the feedback signal for feedback adjusting intensity or the amplification ratio of the sensed signal.

In another perspective of the present invention, it provides a method for adaptive de-flicker, comprising: receiving a signal with an unstable frequency; sampling the received signal by a high frequency to obtain counts indicating high and low level periods of the received signal; when the counts of high and low level periods are stably at first non-zero values, generating an output signal with a stable frequency accordingly; when either count of the high or low level period varies, maintaining the frequency of the output signal without changing it; when either count of the high or low level period is zero, maintaining the frequency of the output signal without changing it; and when the counts of high and low level periods are stably at second non-zero values, generating an output signal with another stable frequency accordingly.

The objectives, technical details, features, and effects of the present invention will be better understood with regard to the detailed description of the embodiments below, with reference to the drawings.

### BRIEF DESCRIPTION OF THE DRAWINGS

FIGS. 1A, 1B and 2 show three embodiments of the present invention, respectively.

FIG. 3 illustrates that the adaptive de-flicker device of the present invention is integrated with a transmission interface circuit to form a system-on-chip (SOC).

FIGS. 4A-4I show several embodiments of the signal processor 20, respectively.

FIGS. 5A-5B, 6A-6B, and 7A-7C show several embodiments of the present invention, respectively.

FIGS. 8-10 show three embodiments of the automatic gain control circuit 30, respectively.

FIG. 11 shows an embodiment of the amplifier 22 (or 22a, 22b)

FIG. 12 shows an embodiment of the clock generator 40.

FIGS. 13-14 illustrate the operation of the delay lock loop (DLL) 42 in the clock generator 40.

### DESCRIPTION OF THE PREFERRED EMBODIMENTS

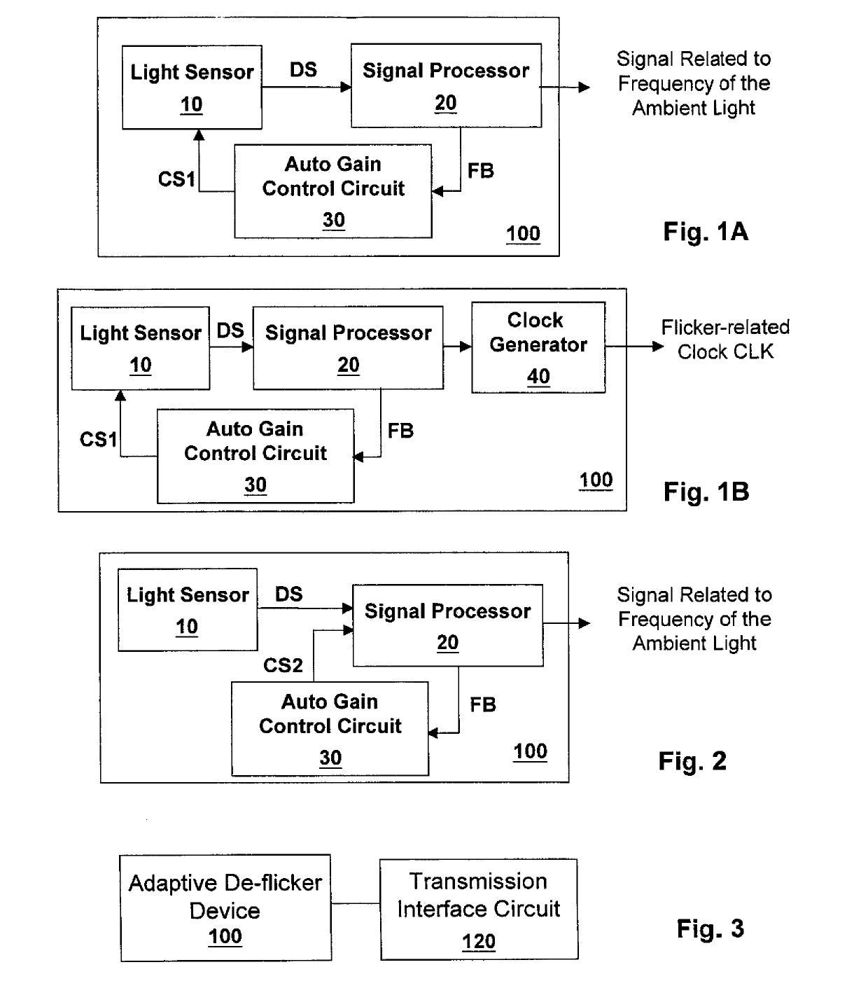

Please refer to FIG. 1A, which shows the first embodiment of the present invention. As shown in the drawing, an adaptive de-flicker device 100 of the present invention includes a light sensor 10, a signal processor 20, and an automatic gain control circuit 30. The light sensor 10 senses ambient light and generates a corresponding sensed signal DS. The signal processor 20 obtains a flicker frequency of the ambient light according to the sensed signal DS outputted from the light sensor 10. After the flicker frequency is obtained, a signal related to a frequency of the ambient light such as a one bit digital signal can be generated, to indicate whether the flicker frequency is 50 HZ or 60 Hz; a subsequent circuit can adjust the exposure time according to the signal related to the frequency of the ambient light for de-flicker. Or, the signal related to the frequency of the ambient light can be a digital or an analog signal with a flicker frequency, such as a square wave or a sine wave signal, and the subsequent circuit can adjust the exposure time according to the frequency of the switching signal for de-flicker. Or yet, the signal related to a frequency of the ambient light can be a signal indicating: a frequency, a period, or an amount of change of a frequency or a period, of the sensed signal; or a signal indicating an error between a frequency or a period of the sensed signal and a predetermined setting.

Because the brightness of the ambient light may change due to various reasons (such as turning-off some light sources, turning-on a new light source, or light being obscured by some object, etc.), the present invention additionally provides an automatic gain control circuit 30 to perform feedback adjustment in response to the brightness change of the ambient light, so that the overall circuitry can operate more accurately to generate a more accurate output signal. More specifically, in this embodiment, the signal processor 20 generates not only the signal related to the frequency of the ambient light signal, but also a feedback signal FB related to brightness of the ambient light. The automatic gain control circuit 30 generates a first control signal CS1 according to the feedback signal FB for feedback controlling and adjusting the light sensor 10 to compensate the sensed signal DS: to increase the intensity of the sensed signal DS when the brightness of the ambient light is too low, and to decrease the intensity of the sensed signal DS when the brightness of the ambient light is too high, such that the signal processor 20 can operate accurately without being negatively impacted by the brightness of the ambient light, and that the adaptive de-flicker device 100 can output the signal related to the frequency of the ambient light precisely.

FIG. 1B shows another embodiment of the present invention. As shown in the drawing, the adaptive de-flicker device of this embodiment comprises a light sensor 10, a signal processor 20, an automatic gain control circuit 30, and a clock generator 40. This embodiment is different from the previous embodiment in that, in this embodiment, after the flicker frequency is obtained, the clock generator 40 generates a clock CLK related to the flicker frequency; for example, when the flicker frequency is 60 Hz, the clock CLK can be 60 Hz, 30 Hz, 20 Hz, etc. Other than used for adjusting the exposure time, this clock CLK can also be used as a synchronization signal among multiple video cameras taking videos concurrently, or as a line lock frequency.

Please refer to FIG. 2, which shows another embodiment of the present invention. As shown in the drawing, an adaptive de-flicker device 100 of the present invention includes a light sensor 10, a signal processor 20, and an automatic gain control circuit 30. Similar to the first embodiment, the light sensor 10 senses an ambient light and generates a corresponding sensed signal DS. The signal processor 20 obtains a flicker frequency of the ambient light according to the sensed signal DS outputted from the light sensor 10. After the flicker frequency is obtained, a signal related to the frequency of the ambient light can be generated. In this embodiment, The automatic gain control circuit 30 generates a second control signal CS2 according to the feedback signal FB, for feedback controlling and adjusting the signal processor 20 such that the signal processor 20 can operate accurately without being negatively impacted by the brightness of the ambient light, and that the adaptive de-flicker device 100 can output the signal related to the frequency of the ambient light precisely.

The aforementioned embodiments can be combined in various ways. For example, the automatic gain control circuit 30 is not limited to generating only one of the control signals CS1 and CS2; instead, it can generate both the signals CS1 and CS2 for feedback controlling both the light sensor 10 and the signal processor 20.

FIG. 3 shows that the adaptive de-flicker device 100 of the present invention can be integrated with a transmission interface circuit 120 to form a system-on-chip (SOC). The transmission interface circuit 120 for example can be I2C, SPI, or USB interface circuit, etc.

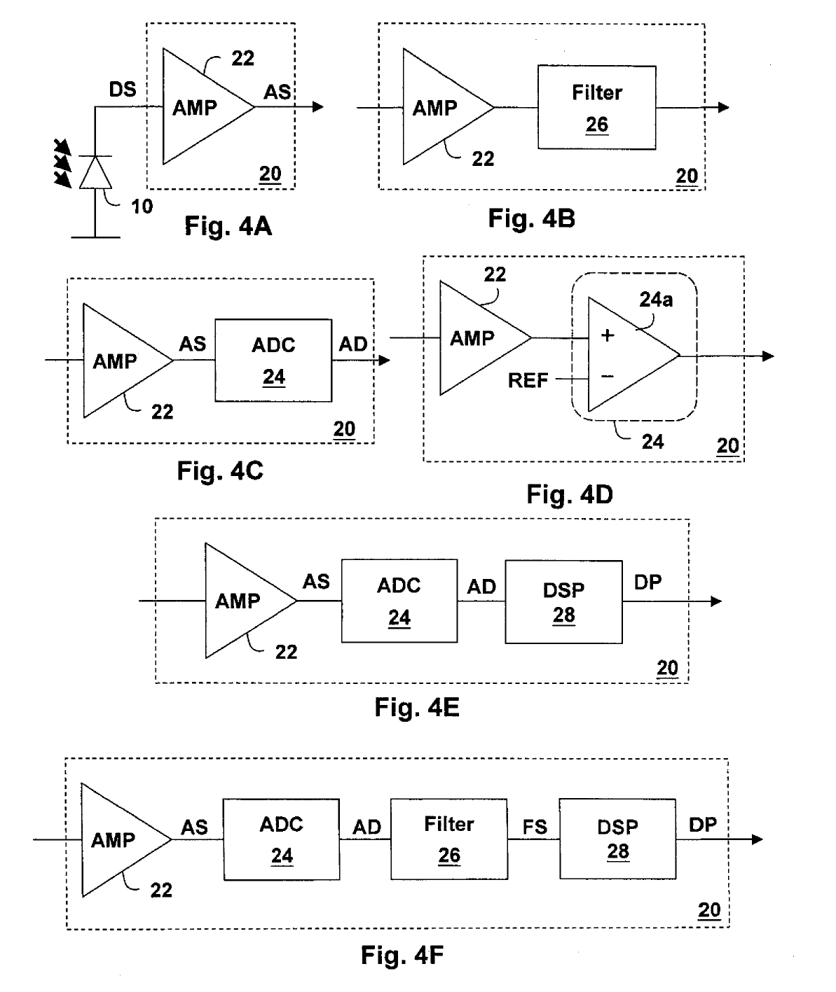

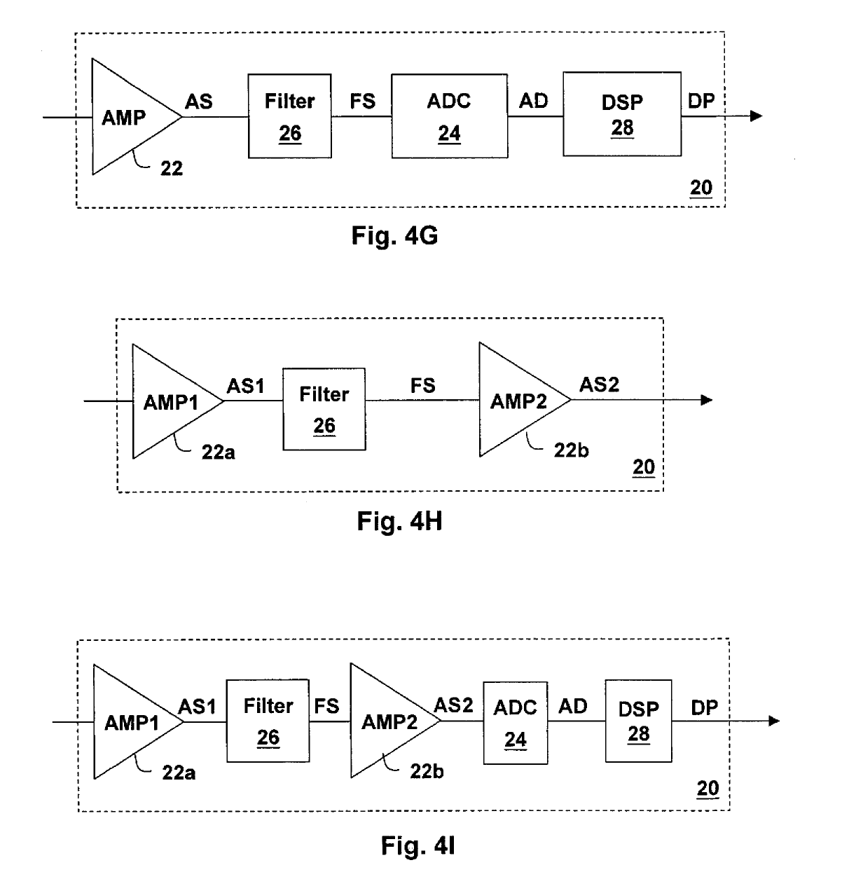

The signal processor 20 can be embodied by various ways, and FIG. 4A illustrates one of the embodiments. The light sensor 10 for example can be a photo diode which generates the sensed signal DS as it receives photons. The signal processor 20 includes an amplifier 22, which amplifies the sensed signal DS generated by the photo sensor 10 to generate an amplified signal AS. This is the simplest form of the signal processor 20 which is capable of outputting an analog signal with a flicker frequency.

FIG. 43 shows another embodiment of the present invention, wherein a filter 26 is further provided next to the amplifier 22. This filter 26 for example can be a low pass filter or a band pass filter for filtering high frequency noises, or for retaining a signal with a frequency in (but not limited to) a range from slightly lower than 50 Hz to slightly higher than 60 Hz.

FIG. 40 shows another embodiment of the present invention. For easier signal processing, the signal processor 20 can be further provided with an analog to digital converter (ADC) 24 for converting the amplified analog signal AS to a digital signal AD. The analog to digital converter 24 is not required to be a complicated converter (yet, certainly it may be so), and its simplest form can be only one comparator, such as the comparator 24a in FIG. 4D. Thus, the analog signal can be converted to a digital signal.

After the amplified analog signal AS is converted to the digital signal AD, for example as shown in FIG. 4E, the digital signal AD can be further processed by a digital signal processing (DSP) circuit 28 to generate a more sophisticated signal DP for more sophisticated use. The DSP circuit 28 is only one example; it can be replaced by any circuit that is capable of processing a digital signal, such as a micro-controller unit (MCU) or an application-specific integrated circuit (ASIC), etc.

The digital signal AD converted from the analog signal AS can be filtered by a filter 26 to generate a filtered signal FS. Or, the analog signal AS can be filtered by the filter 26 first, and next converted to the digital signal AD, as shown in FIGS. 4F and 4G.

Furthermore, as shown in FIG. 4H, a two-stage amplification can be performed in the signal processor 20. First, a first amplifier 22a amplifies the sensed signal DS, and generates an amplified signal AS1 which contains DC and AC components. Next, the filter 26 filters the DC component of the signal S1 and retains the AC component (the filtered signal FS). Subsequently, a second amplifier 22b amplifies the filtered signal FS and generates an amplified signal AS2 which contains only AC component.

The circuit in FIG. 4H can be further modified. An ADC and/or a DSP circuit, etc., can be provided after the second amplifier 22b as shown in FIG. 4I. Besides the above examples, the signal processor 20 can be embodied in still other forms. For example, the sensed signal obtained by the light sensor 10 can be filtered to remove the DC component first, and then it is amplified, etc. Those skilled in the art can readily think of many variations under the above teachings.

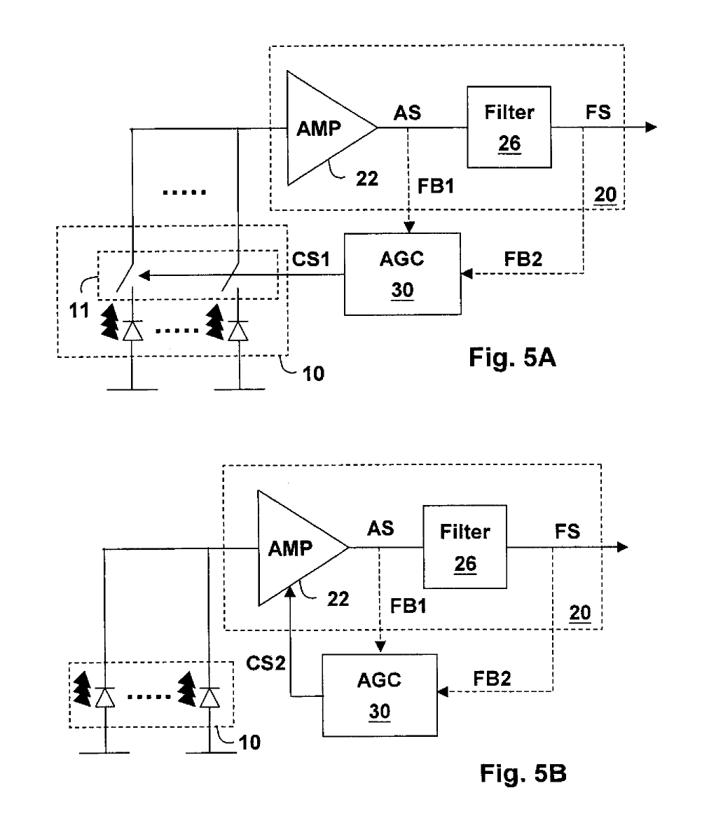

FIG. 5A shows another embodiment of the present invention in more specific details. In this embodiment, the light sensor 10 includes a plurality of light sensing devices and a switch circuit 11 having a plurality of switches for selectively coupling corresponding one or more of the plurality of light sensing devices to the signal processor 20. The light sensing devices can be of the same size or different sizes. For example, the ratio of the sizes can be 1:1:1:1, 1:2:4:8, or other ratios. The automatic gain control circuit (AGC) 30 can obtain the feedback signal from the output of the amplifier 22 (path FB1) or from the output of the filter 26 (path FB2), as shown by the dash lines (meaning that the circuit can obtain the feedback signal from either one of the paths, same meaning in the following drawings). In this embodiment, the automatic gain control circuit 30 receives and processes the feedback signal, and outputs a first control signal CS1. As shown in the figure, the first control signal CS1 can be a switch control signal for controlling the plurality of switches of the switch circuit 11, to couple the selected light sensing devices to the signal processor 20. For example, when the brightness of the ambient light is relatively low, the first control signal CS1 selects more or larger size light sensing devices and couple them to the signal processor 20 to increase the intensity of the input signal to the amplifier 22. On the contrary, when the brightness of the ambient light is relatively high, the first control signal CS1 selects less or smaller size light sensing devices and couple them to the signal processor 20 to decrease the intensity of the input signal to the amplifier 22. Thus, the signal processor 20 can operate accurately without being negatively impacted by the brightness of the ambient light, and the overall circuitry can output the signal related to the frequency of the ambient light precisely.

FIG. 5B shows another embodiment of the present invention in more specific details. Likely, the automatic gain control circuit (AGC) 30 can obtain the feedback signal from the output of the amplifier 22 (path FB1) or from the output of the filter 26 (path FB2). The automatic gain control circuit 30 receives and processes the feedback signal, and outputs a second control signal CS2. As shown in the figure, the second control signal CS2 feedback controls the amplifier 22 for adjusting the amplified signal AS. For example, when the brightness of the ambient light is relatively low, the second control signal CS2 increases the amplification ratio to increase the amplified signal AS. On the contrary, when the brightness of the ambient light is relatively high, the second control signal CS2 decreases the amplification ratio to decrease the amplified signal AS. Thus, the signal processor 20 can operate accurately without being negatively impacted by the brightness of the ambient light, and the overall circuitry can output the signal related to the frequency of the ambient light precisely.

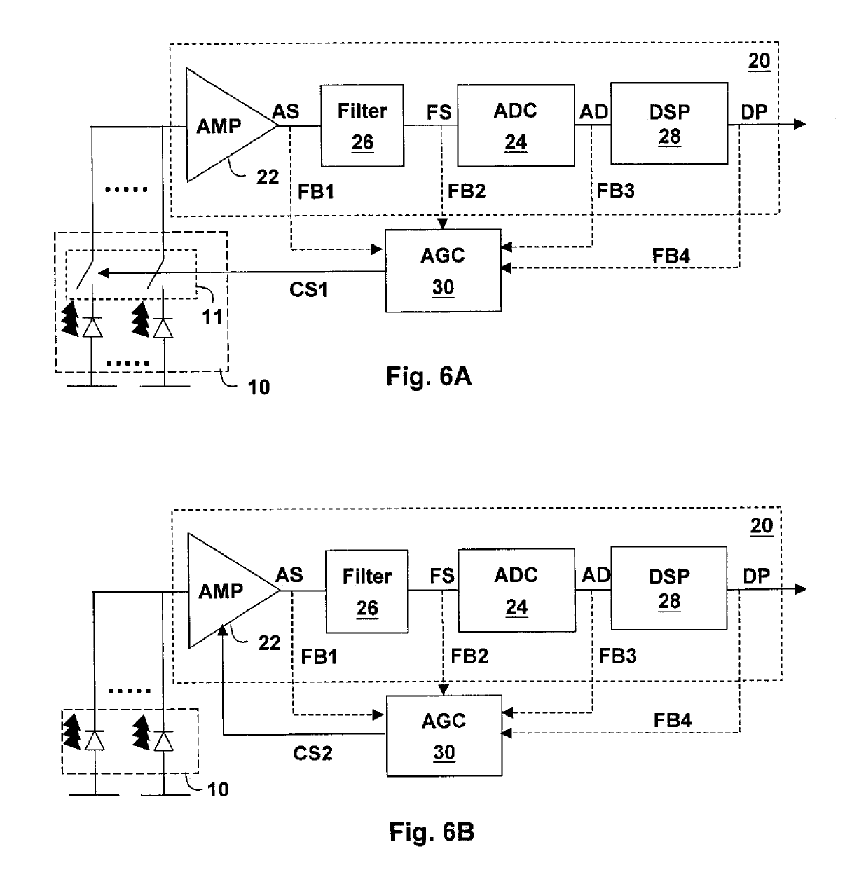

Similarly, FIGS. 6A and 6B show that the feedback signal can be obtained from anyone of the output of the amplifier 22 (path FB1), the output of the filter 26 (path FB2), the output of the ADC circuit 24 (path FB3), and the output of the DSP circuit 28 (path FB4). And the AGC circuit 30 may control the light sensor 10 (FIG. 6A) or the amplifier 22 (FIG. 6B).

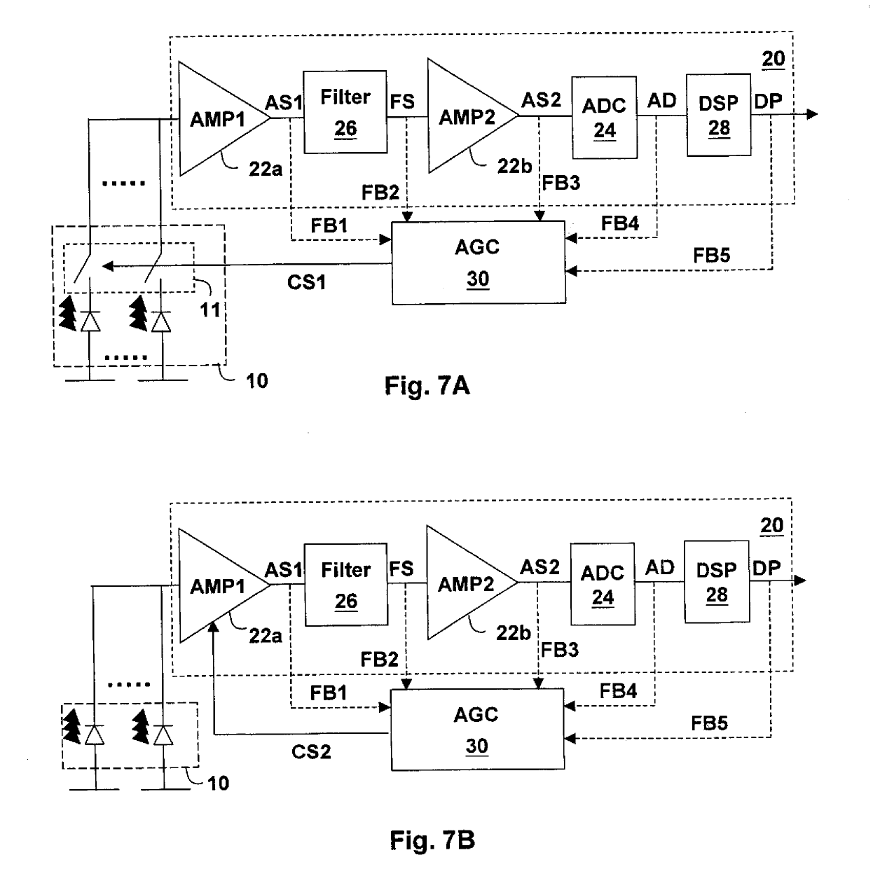

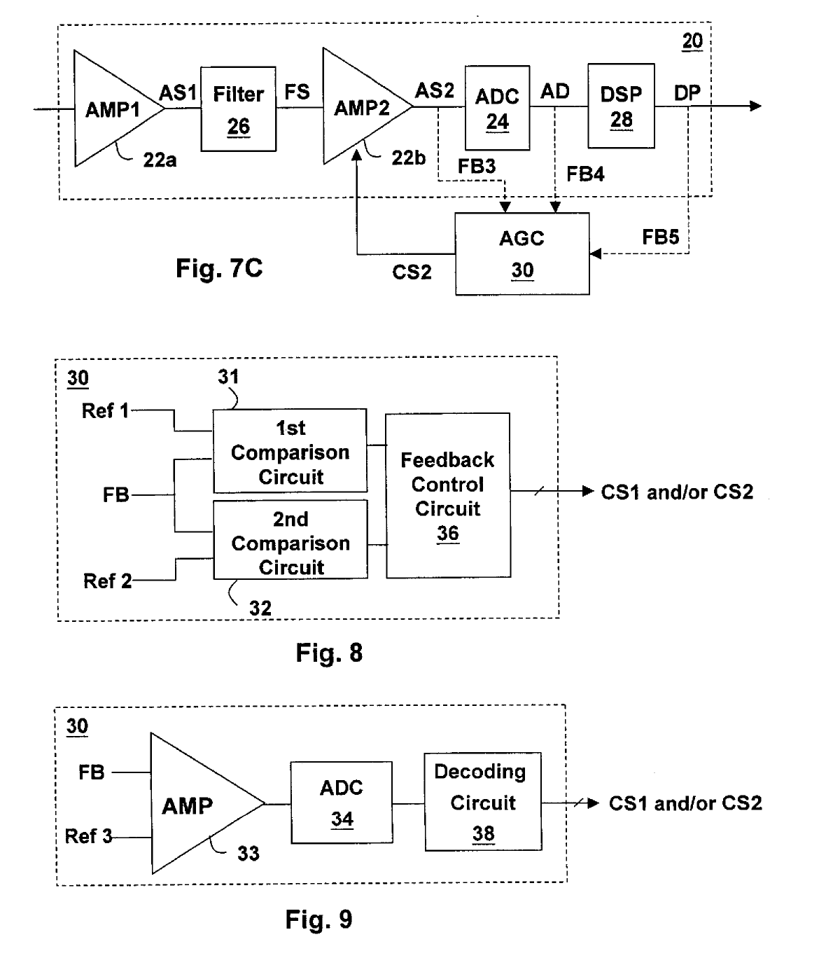

When the signal processor 20 performs two-stage amplification, as shown in FIGS. 7A-7C, the AGC circuit 30 may control the light sensor 10 (FIG. 7A), the first amplifier 22a (FIG. 7B), or the second amplifier 22b (FIG. 7C). In the FIGS. 7A and 7B, the feedback signal may be obtained from anyone of the output of the first amplifier 22a (path FB1), the output of the filter 26 (path FB2), the output of the second amplifier 22b (path FB3), the output of the ADC circuit 24 (path FB4), and the output of the DSP circuit 28 (path FB5). In the FIG. 7C, the feedback signal may be obtained from anyone of the output of the second amplifier 22b (path FB3), the output of the ADC circuit 24 (path FB4), and the output of the DSP circuit 28 (path FB5).

In the above embodiments shown in FIGS. 5A, 5B, 6A, 6B, 7A, 7B, and 7C, certainly, the AGC circuit 30 can also output both control signals CS1 and CS2 for controlling the light sensor 10 and the amplifier 22 in the same time, or controlling the light sensor 10 and the amplifiers 22a and/or 22b in the same time.

There are many ways to embody the AGC circuit 30, and FIG. 8 shows one of the examples. The feedback signal FB in this embodiment for example may be obtained from anyone of the aforementioned paths FB1-FB5. A first comparison circuit 31 compares the feedback signal FB with a first reference signal Ref1 for determining whether the brightness of the ambient light is too high. A second comparison circuit 32 compares the feedback signal FB with a second reference signal Ref2 for determining whether the brightness of the ambient light is too low. A feedback control circuit 36 generates control signals CS1 and/or CS2 according to the results from the comparison circuits, for feedback controlling and adjusting the light sensor 10 or the signal processor 20, to decrease the intensity of the output signal of the light sensor 10 or to decrease the amplification ratio of the amplifier 22 when the brightness of the ambient light is too high, and to the contrary when the brightness of the ambient light is too low. The aforementioned comparison circuits 31 and 32 may be analog or digital circuits, such as operational amplifiers or comparators, depending on whether the feedback signal FB is an analog signal or a digital signal. Certainly, the AGC circuit 30 is not limited to including only two comparison circuits 31 and 32; more number of comparison circuits can be used for more sophisticated adjustments.

FIG. 9 shows another embodiment of the AGC circuit 30. The feedback signal FB in this embodiment for example is an analog signal. An operational amplifier 33 compares the feedback FB with a third reference signal Ref3, and the difference indicates the brightness state of the ambient light. An ADC circuit 34 converts the output of the operational amplifier 33 to a digital signal. A decoding circuit 38 generates a control signal CS1 or CS2 according to the digital signal. The circuit may operate for example as follows. When the difference outputted from the operational amplifier 33 is in an extremely low range indicating that the brightness of the ambient light is extremely low, the intensity of the output signal of the light sensor or the amplification ratio of the amplifier 22 is increased significantly; when the difference outputted from the amplifier 33 is in a less lower range indicating that the brightness of the ambient light relatively is somewhat low, the intensity of the output signal of the light sensor or the amplification ratio of the amplifier 22 is increased slightly; when the difference outputted from the amplifier 33 is in a relatively high range indicating that the brightness of the ambient light is somewhat high, the intensity of the output signal of the light sensor or the amplification ratio of the amplifier 22 is not adjusted; when the difference outputted from the amplifier 33 is in an extremely high range indicating that the brightness of the ambient light is extremely high, the intensity of the output signal of the light sensor or the amplification ratio of the amplifier 22 is decreased significantly, and so on. Certainly, the aforementioned four-stage adjustment may be modified to fewer or more stages.

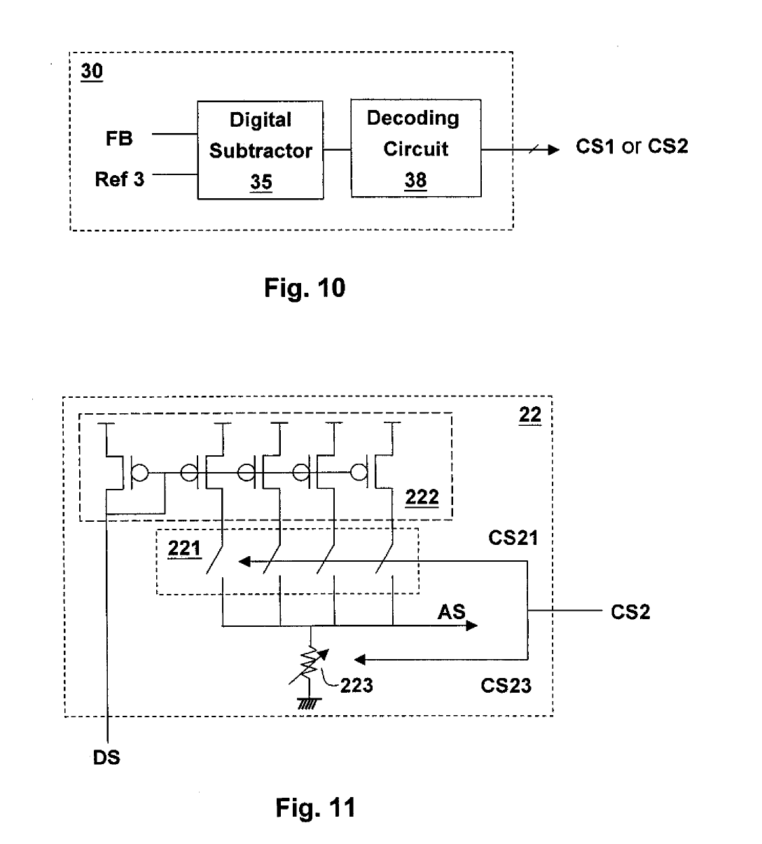

When the feedback signal FB is a digital signal, the operational amplifier 33 can be replaced by a digital subtractor 35, and the ADC circuit 34 can be omitted. The AGC circuit 30 shown in FIG. 10 can provide the same function as the above.

There are many ways to embody the amplifier 22 (and 22a, 22b). FIG. 11 shows one of the examples. In this embodiment, the amplifier 22 includes a switch circuit 221, a current mirror 222, and a variable resistor 223. The current mirror 222 has a plurality of current duplication paths, and the current ratio of the paths for example may be 1:1:1:1, 1:2:4:8, or other ratios, for duplicating and amplifying the sensed signal DS. The switch circuit 221 has a plurality of switches controlled by a control signal CS21 for selectively coupling corresponding one or more of the plurality of current paths to a variable resistor 223. Thus, the amplified signal AS is equal to the current through the variable resistor 223 multiplies its resistance. The resistance of the variable resistor 223 is controlled and adjustable by the control signal CS23. As such, the amplification ratio of the amplified signal AS to the sensed signal DS can be adjusted by the control signal CS21 and/or the control signal CS23. That is, the aforementioned control signal CS2 for controlling the amplifier 22 may be one or both of CS21 and CS23. When the brightness of the ambient light is relatively low, more switches of the switch circuit 221 can be turned on and/or the resistance of the variable resistor 23 can be adjusted, to increase the amplified signal AS; and to the contrary when the brightness of the ambient light is relatively high. Certainly, if only the control signal CS21 is provided, the variable resistor 223 can be a simple resistor instead of a variable resistor; if only the control signal CS23 is provided, the current mirror 222 can have only one single current duplication path instead of plural current duplication paths.

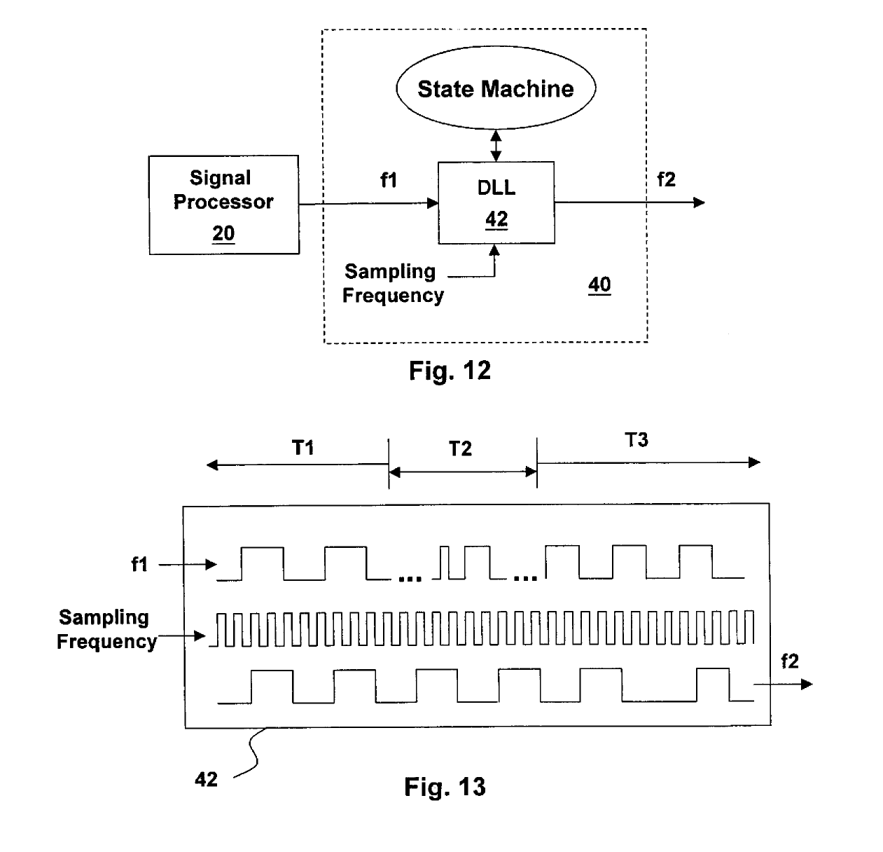

The clock generator 40 in FIG. 1B can be embodied by various ways, of which one embodiment is shown in FIG. 12. In this embodiment, the clock generator 40 includes a delay lock loop (DLL) 42 which samples the output signal of the signal processor 20 (with a frequency f1) according to a sampling frequency and duplicates it to generate a stable output signal with a frequency f2. Depending on the requirement, the clock generator 30 can be further provided with a frequency division circuit to generate a stable output signal with a frequency f3 according to the signal f2.

Please refer to FIG. 13. The flicker frequency obtained from the ambient light is not always stable. However, the clock generator 40 formed by the DLL 42 of the present invention can still generate a stable output signal for the subsequent circuit. As shown in FIG. 13, in time period T1, the output signal of the signal processor 20 is in a first stable state (e.g., 50 Hz), and the DLL 42 also generates a signal f2 of a corresponding frequency according to the signal f1. The signal f2 is generated by counting the numbers of high level clocks and low level clocks of the signal f1 by a high frequency sampling signal, and duplicating the length of the high and low levels to generate the signal f2. In time period T2, the output signal of the signal processor 20 is lost or unstable (e.g., when the ambient light is too weak or when the user changes to a new location). In this case, the output signal of the DLL 42 maintains its previous frequency. In time period T3, the output signal of the signal processor 20 changes to a second stable state (e.g., 60 Hz). In this case, after several cycles to confirm the new state, the DLL 42 generates the signal f2 with a corresponding new frequency.

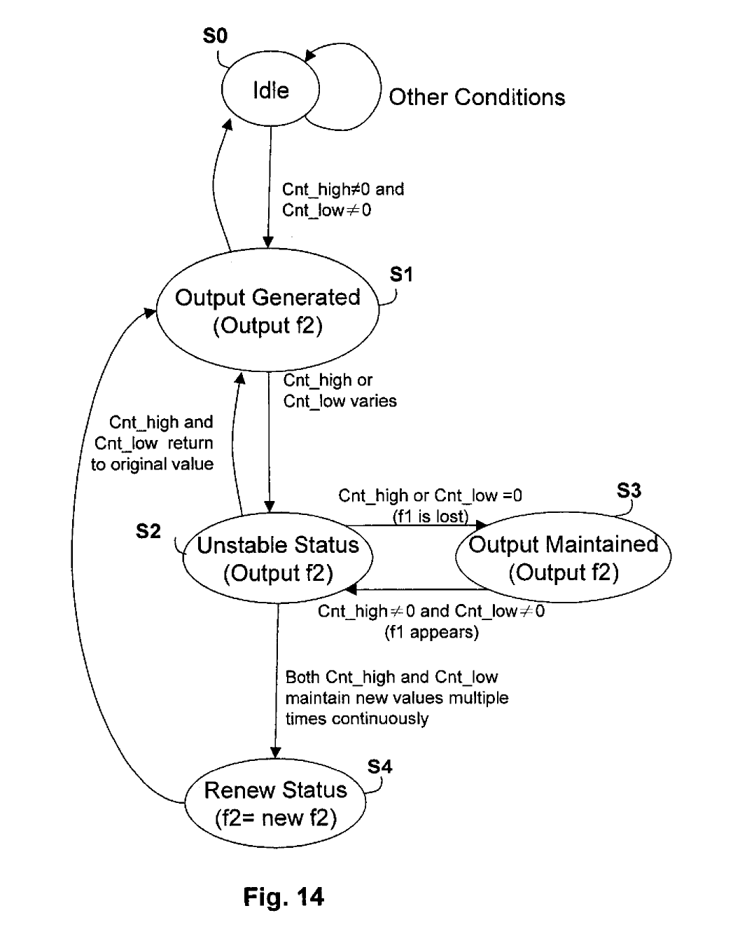

A state machine of the DLL 42 is shown in FIG. 14. In state SO, the DLL 42 is in an idle state. When both the high level clock number (Cnt_high) and the low level clock number (Cnt_low) are not 0, it indicates that the signal f1 is received, so the DLL 42 enters the state S1 and generates the signal f2. When (Cnt_high) or (Cnt_low) varies, the DLL 42 enters the state S2, which is an unstable state, but the DLL 42 maintains the signal f2 with the previous frequency. In the state S2, if (Cn_high) and (Cnt_low) return to the previous value, the DLL 42 returns to the state S1. If either (Cnt_high) or (Cnt_low) is 0, it indicates that the signal f1 is lost, so the DLL 42 enters the state S3, but still maintains the signal f2 with the previous frequency. In the state S3, if both (Cn_high) and (Cnt_low) are not 0, it indicates that the signal f1 appears again; in this case, the DLL 42 returns to the state S2. In the state S2, if (Cn_high) and (Cnt_low) maintain stable new values multiple times, the DLL 42 enters the state S4 such that the signal f2 is changed to a new frequency, and next the DLL 42 returns to the state S1 in which it is operated under the new frequency.

Note that, in FIGS. 1B and 12, the clock generator 40 and the signal processor 20 are drawn separately for better understanding the concept of the present invention. In fact, the clock generation can be achieved within the signal processor 20, not necessarily outside the signal processor 20. The function of the aforementioned DLL 42 and its state machine can be provided inside the signal processor 20, such as performed by a signal processor (or a micro-controller unit, etc.).

Compared with the prior art, the present invention is more advantageous because it can adaptively sense and eliminate the flicker in the ambient light, which is a great benefit to a portable device. In addition, the present invention can support a function for synchronization or line lock among multiple video cameras. Besides the above, by the feedback adjustment of the AGC circuit 30 disclosed in the present invention, the overall circuitry can operate in a better condition, to output a signal related to the frequency of the ambient light more precisely.

The present invention has been described in considerable detail with reference to certain preferred embodiments thereof. It should be understood that the description is for illustrative purpose, not for limiting the scope of the present invention. Those skilled in this art can readily conceive variations and modifications within the spirit of the present invention. For example, any function performed by a single hardware circuit in the drawing can be performed by multiple hardware circuits or software instead. As another example, in the embodiment shown in FIG. 2, a switching signal can be generated from the signal processor 20, in addition to the clock CLK. In view of the foregoing, the spirit of the present invention should cover all such and other modifications and variations, which should be interpreted to fall within the scope of the following claims and their equivalents.

What is claimed is:

1. An adaptive de-flicker device, comprising:
a light sensor for sensing ambient light and generating a corresponding sensed signal;
a signal processor coupled to the light sensor, for generating a signal related to a frequency of the ambient light and a feedback signal according to the sensed signal; and
an automatic gain control circuit coupled to the signal processor, for generating a control signal according to the feedback signal, to adjust the sensed signal by feedback controlling the light sensor, or to adjust the signal related to the frequency of the ambient light by feedback controlling the signal processor.

2. The adaptive de-flicker device of claim 1, wherein the automatic gain control circuit adjusts intensity of the sensed signal generated by the light sensor according to the feedback signal.

3. The adaptive de-flicker device of claim 1, wherein the signal processor includes an amplifier amplifying the sensed signal generated by the light sensor, and wherein the automatic gain control circuit adjusts the amplification ratio of the amplifier according to the feedback signal.

4. The adaptive de-flicker device of claim 1, wherein the automatic gain control circuit includes:
a comparator comparing the feedback signal generated by the signal processor with a reference signal for generating a comparison result; and
a feedback control circuit generating the control signal according to the comparison result generated by the comparator.

5. The adaptive de-flicker device of claim 1, wherein the automatic gain control circuit includes:
an operational amplifier comparing the feedback signal generated by the signal processor with a reference signal;
an analog to digital conversion circuit converting an output signal of the operational amplifier to a digital signal; and
a decoding circuit generating the control signal according to the digital signal outputted from the analog to digital conversion circuit.

6. The adaptive de-flicker device of claim 1, wherein the automatic gain control circuit includes:
a digital subtraction circuit subtracting a reference signal from the feedback signal generated from the signal processor; and
a decoding circuit generating the control signal according to an output of the digital subtraction circuit.

7. The adaptive de-flicker device of claim 1, wherein the light sensor includes:
a plurality of light sensing devices; and
a plurality of switches controlled by the control signal for selectively coupling one or more of the plurality of light sensing devices to the signal processor.

8. The adaptive de-flicker device of claim 3, wherein the amplifier includes:
a current mirror circuit comprising at least one current duplication path for amplifying the sensed signal; and
at least one switch corresponding to the current duplication path, controlled by the control signal for conducting the corresponding current duplication path.

9. The adaptive de-flicker device of claim 3, wherein the amplifier includes:
a current mirror circuit comprising at least one current duplication path for amplifying the sensed signal; and
a variable resistor coupled to the current duplication path, the variable resistor having a variable resistance controlled by the control signal.

10. The adaptive de-flicker device of claim 1, wherein the signal related to the frequency of the ambient light includes one or more of the followings:
a one-bit digital signal indicating a frequency of 50 Hz or 60 Hz;
a digital or analog signal with a flicker frequency;
a signal indicating: a frequency, a period, or an amount of change of a frequency or a period, of the sensed signal; and
a signal indicating an error between a frequency or a period of the sensed signal and a predetermined setting.

11. The adaptive de-flicker device of claim 1, wherein the adaptive de-flicker device is integrated with a transmission interface circuit to form a system-on-chip (SOC).

12. The adaptive de-flicker device of claim 11, wherein the transmission interface circuit is one of an I2C, SPI, and USB interface circuit.

13. The adaptive de-flicker device of claim 1, further comprising a clock generator coupled to the signal processor, for generating a clock signal related to the flicker frequency of the ambient light according to an output signal of the signal processor, wherein the clock generator includes: a delay lock loop (DLL) generating a signal with a stable frequency according to a frequency of the output signal of the signal processor.

14. A method for adaptive de-flicker, comprising:
sensing ambient light and generating a corresponding sensed signal;
amplifying the sensed signal;
generating a signal related to a frequency of the ambient light and a feedback signal according to the amplified sensed signal; and
generating a control signal according to the feedback signal for feedback adjusting intensity or amplification ratio of the sensed signal.

15. The method of claim 14, wherein the step of generating a control signal according to the feedback signal includes:
comparing the feedback signal with a reference signal; and
generating the control signal according to the comparison result.

16. The method of claim 14, wherein the step of generating a control signal according to the feedback signal includes:
subtracting a reference signal from the feedback signal; and
generating the control signal according to the result of the subtracting step.

17. The method of claim 16, wherein the step of generating a control signal according to the feedback signal further includes:
performing analog to digital conversion on result of the subtracting step.

18. The method of claim 14, wherein the step of feedback adjusting intensity of the sensed signal includes:
providing a plurality of light sensing devices; and
providing a plurality of switches controlled by the control signal for selectively coupling one or more of the plurality of light sensing devices to adjust the intensity of the sensed signal.

19. The method of claim 14, wherein the step of feedback adjusting amplification ratio of the sensed signal includes:
providing a current mirror circuit comprising at least one current duplication path for amplifying the sensed signal; and
providing at least one switch corresponding to the current duplication path, controlled by the control signal for selectively conducting the corresponding current duplication path to adjust the amplification ratio of the sensed signal.

20. The method of claim 14, wherein the step of feedback adjusting amplification ratio of the sensed signal includes:
providing a current mirror circuit comprising at least one current duplication path for amplifying the sensed signal; and
providing a variable resistor coupled to the current duplication path, the variable resistor having a variable resistance controllable by the control signal.

21. The method of claim 14, further comprising:
sampling the signal related to the frequency of the ambient light by a sampling frequency, and duplicating the frequency of the ambient light to generate a signal with a stable frequency.

22. A method for adaptive de-flicker, comprising:
receiving a signal with an unstable frequency;
sampling the received signal by a high frequency to obtain counts indicating high and low level periods of the received signal;
when the counts of high and low level periods are stably at first non-zero values, generating an output signal with a stable frequency accordingly;
when either count of the high or low level period varies, maintaining the frequency of the output signal without changing it;
when either count of the high or low level period is zero, maintaining the frequency of the output signal without changing it; and
when the counts of high and low level periods are stably at second non-zero values, generating an output signal with another stable frequency accordingly.
